(19) United States
(12) Patent Application Publication
(10) Pub. No.: US 2026/0307628 A1
(43) Pub. Date: Oct. 8, 2026

(54) VEHICLE BRAKING CONTROL SYSTEM

(71) Applicant: FORD GLOBAL TECHNOLOGIES, LLC, Dearborn, MI (US)

(72) Inventors: Florentino Alberto Barrita Gutierrez, Mexico City (MX); Roberto Villegas Muriel, Atizapan de Zaragoza (MX); Thomas Svensson, Leichlingen (DE); Harold John Felch, Novi, MI (US)

(21) Appl. No.: 19/171,503

(22) Filed: Apr. 7, 2025

(51) Int. Cl. B60T 7/04

(52) U.S. Cl. CPC B60T 7/042

(57) ABSTRACT

A vehicle brake system includes a brake, an electronic pedal system, and one or more controllers—such as redundant brake modules—that support both normal and fallback braking modes. The system generates a wakeup signal when the pedal is engaged and a control signal based on the travel of the pedal arm. In wake mode, the controllers apply the brake based on the control signal if it is present and valid. If the signal is absent or faulty, the system overrides pedal input and applies braking to achieve a predefined vehicle slowing rate. Wake pins remain inactive during normal operation but become active in fallback scenarios.

### TECHNICAL FIELD

Various embodiments relate to backup signals and in braking systems in a vehicle.

### BACKGROUND

Vehicle communications occur according to various signal routes. Redundant communication paths make communication possible even if one of the communication paths is unavailable.

### BRIEF DESCRIPTION OF THE DRAWINGS

FIG. 1 is an example electric vehicle with a braking system.

FIG. 2 is an example circuit configuration for a vehicle having a braking system.

FIG. 3A is an example timeline illustrating voltage associated with a wakeup signal.

FIG. 3B is an example timeline illustrating signals indicating pedal travel after reception of a wakeup signal.

FIG. 3C is an example timeline illustrating application of brake force and vehicle rate of speed decrease after reception of a wakeup signal.

FIG. 4 is an example process for application of brake force after reception of a wakeup signal.

### SUMMARY

A vehicle brake system, in some examples, includes a brake and an electronic pedal system comprising a pedal arm and circuitry configured to generate a wakeup signal upon engagement and a control signal based on the pedal arm’s travel. One or more controllers, such as redundant brake modules, are programmed to enter a wake mode in response to the wakeup signal. While in this mode, if the control signal is present and not faulty, the controllers actuate the brake according to the signal’s parameter value. If the control signal is absent or faulty, the controllers override pedal travel and actuate the brake to achieve a predefined target vehicle rate of slowing. The electronic pedal system also includes wake pins that remain inactive when the control signal is valid but become active if the signal is absent or faulty during the wake mode. Additionally, the system may include a parking brake that is actuated after the vehicle is brought to a stop using the target slowing protocol.

In some examples, a method involves actuating a vehicle brake based on a parameter value derived from the travel of a brake pedal arm, as defined by a corresponding control signal. If the control signal is faulty or absent, the method instead actuates the brake to achieve a target vehicle rate of speed decrease, independent of pedal travel. In such scenarios, the method also includes activating a plurality of wake pins designed to receive a wakeup signal, which is generated upon engagement of the brake pedal arm. Additionally, after the vehicle has been brought to a stop through braking to the target rate of speed decrease, the method includes actuating a parking brake.

A vehicle brake control system, in some examples, includes one or more brake controllers configured to actuate a brake based on a control signal that defines a parameter value corresponding to brake pedal arm travel. If the control signal is absent or faulty, the controllers override pedal input and actuate the brake to achieve a predefined target vehicle slowing rate. The system may incorporate redundant brake modules, such as a first, second, and third brake module. While operating in the fallback mode (i.e., targeting the fixed slowing rate), the system keeps wake pins—configured to receive a wakeup signal—active. The controllers are also programmed to generate the control signal upon engagement of the pedal arm and, after stopping the vehicle via the fallback braking mode, to actuate a parking brake.

### DETAILED DESCRIPTION

A vehicle computer may include a processor that can monitor subsystem operations and arbitrate subsystem faults. Arbitrating subsystem issues could include rerouting communications from one subsystem to another subsystem. Common E-pedal design utilizes four pedal travel control signals in order to create brake signal redundancy. Brake modules are awoken in order to monitor pedal travel based on the travel signals in response to a wakeup signal indicative of a minimum force applied to the brake pedal. It is, however, possible in certain scenarios that each of the control signals may experience an issue rendering the control signal unusable for the purposes of brake actuation. One solution to such a scenario to use the wakeup signal to actuate the brake subsystems.

Detailed embodiments are provided below. These embodiments, however, are intended solely as examples and may take various alternative forms and configurations. The accompanying figures are not drawn to scale. Certain features may be exaggerated, minimized, or omitted to highlight specific details of particular components. Consequently, the structural and functional details described herein are not to be interpreted as limiting but rather as illustrative examples to guide those skilled in the art in applying the described concepts in different ways.

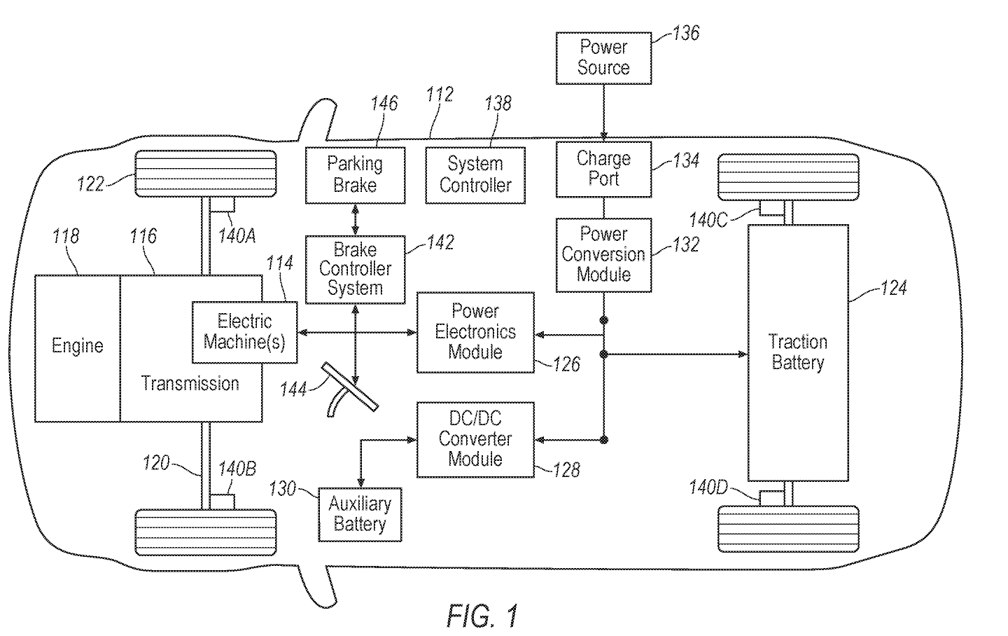

FIG. 1 illustrates an example vehicle 112, which may be a plug-in hybrid-electric vehicle (PHEV). The plug-in hybrid-electric vehicle 112 includes one or more electric machines 114 that are mechanically coupled to a gearbox or hybrid transmission 116. These electric machines 114 can function as both motors and generators. Additionally, the hybrid transmission 116 is mechanically connected to an engine 118 and a drive shaft 120, which is further coupled to wheels 122. The electric machine 114 is operably coupled to wheels 122. A gearbox (not shown) may be included to change a speed ratio between the electric machine 114 and the wheels 122. The electric machine 114 may be one or more electric machines. The electric machine 114 is capable of acting as motor to provide a positive torque to propel the vehicle 112 and is capable of acting as a generator to provide a negative torque to brake the vehicle 112 such as via regenerative braking. The electric machine 114 may be a permanent magnet three-phase alternating current (AC) electric motor or other suitable type. The electric machines 114 provide propulsion capabilities, regardless of whether the engine 118 is running. They can also operate as generators, enhancing fuel efficiency by recovering energy that would otherwise be lost as heat through a friction braking system.

The vehicle 112 may also be configured as a battery electric vehicle (BEV), in which case the engine 118 would not be present. Alternatively, the vehicle 112 could be a full hybrid-electric vehicle (FHEV) without plug-in capabilities. Another potential configuration is a fuel-cell electric vehicle (FCEV).

A traction battery 124 stores energy that can be used by the electric machines 114. This battery may provide a high-voltage direct current (DC) output. A power electronics module 126, also known as an inverter, is electrically connected to the electric machines 114 and a DC/DC converter module 128. These modules facilitate the bi-directional transfer of energy between the traction battery 124 and the electric machines 114. For example, while the traction battery 124 provides DC voltage, the electric machines 114 typically require three-phase alternating current (AC) for operation. The power electronics module 130 converts the DC voltage to AC for propulsion and, in regenerative mode, converts the AC generated by the electric machines 114 back into DC to recharge the traction battery 124.

In addition to powering propulsion systems, the traction battery 124 supplies energy to other electrical systems in the vehicle 112. The DC/DC converter module 128 converts the high-voltage DC to a low-voltage DC level which powers low-voltage loads. The converter module 128 can also charge an auxiliary battery 130, such as a 12V battery. The low-voltage loads draw power from the auxiliary battery 130, while high-voltage loads, such as fans, electric heating elements, or air-conditioning compressors, connect directly to the load bus and are controlled by dedicated controllers.

The vehicle 112 may also recharge the traction battery 124 from a power conversion module 132 electrically connected with an external power source 136. The external power source 136 could be an electrical outlet or an electric power distribution network managed by a utility company. The external power source 136 connects to the vehicle 112 through electric vehicle supply equipment (EVSE), which includes circuitry and controls to manage energy transfer. The EVSE may provide either AC or DC power and connect to the vehicle’s charge port 134 using a charge connector. The charge port 134 may be any type of port configured to transfer power from the EVSE to the vehicle 112. The charge port 134 may be electrically coupled to a charger or on-board power conversion module 132. The power conversion module 132 may condition the power supplied from the power source 136 to provide the proper voltage and current levels to the traction battery 124. The power conversion module 132 may interface with the EVSE to coordinate the delivery of power to the vehicle 112. The EVSE connector may have pins that mate with corresponding recesses of the charge port 134. Alternatively, various components described as being electrically coupled or connected may transfer power using a wireless inductive coupling.

Electronic modules within the vehicle 112 may communicate through one or more vehicle networks, which can include multiple channels for data transfer. One channel may include a serial bus, such as a Controller Area Network (CAN). Another channel could be an Ethernet network based on the IEEE 802 family of standards. Additional channels may involve discrete connections between modules and may also include power signals sourced from the auxiliary battery 130.

Different types of signals are routed over specific channels based on their requirements. For instance, video signals may be transmitted over a high-speed channel, such as Ethernet, while control signals may utilize CAN or discrete connections. The vehicle network comprises both hardware and software components that facilitate signal and data exchange among the modules. Although not depicted in FIG. 1, the vehicle network can be assumed to connect to any electronic modules within the vehicle 112.

Additionally, a Vehicle System Controller (VSC) 138 (e.g., one or more controllers) may be included to coordinate the operation of various components throughout the vehicle. The controller(s) 138 are in electric communication with a plurality of vehicle systems and are configured to coordinate functionality of the vehicle 112. The controller 138 may be a vehicle-based computing system that includes one or more controllers that communicate via a serial bus (e.g., controller area network (CAN)) or via dedicated electrical conduits. The controller 138 generally includes any number of microprocessors, ASICs, ICs, memory (e.g., FLASH, ROM, RAM, EPROM and/or EEPROM) and software code to co-act with one another to perform a series of operations. The controller 138 also includes predetermined data, or “lookup tables,” that are based on calculations and test data, and are stored within the memory. The controller 138 may communicate with other vehicle systems and controllers over one or more wired or wireless vehicle connections using common bus protocols (e.g., CAN and LIN). Used herein, any reference to “a controller” refers to one or more controllers. The controller 138 may include a battery energy control module (BECM) that operates at least the traction battery 124, a powertrain control module (PCM) that operates at least the electric machine 114, and a brake control module that controls vehicle systems relating to braking.

The controllers 138 communicate with various vehicle sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. Although not explicitly illustrated, those of ordinary skill in the art will recognize various functions or components that may be controlled by a controller within each of the subsystems identified above.

One or more wheel brakes 140 may be provided for slowing the vehicle 112 and preventing motion of the vehicle 112. The wheel brakes 140 may be hydraulically actuated, electrically actuated, or some combination thereof. The wheel brakes 140 may be a part of a brake system 142. The brake system 142 may include other components to operate the wheel brakes 140. For simplicity, the figure depicts a single connection between the brake system 142 and one of the wheel brakes 140. A connection between the brake system 142 and the other wheel brakes 140 is implied. The brake system 142 may include modules, which may be included in the system controller 138, configured to monitor and coordinate the brake system 142. The brake system 142 may monitor the brake components and control the wheel brakes 140 for slowing the vehicle 112. The brake system 142 may respond to driver commands and may also operate autonomously to implement features such as stability control. The controller of the brake system 142 may implement a method of applying a requested brake force when requested by another controller or sub-function.

The brake system 142 may be a hydraulic system, an electric system, or a combination of electric and hydraulic. The brake systems 142 includes, in addition to various modules and components described in further detail below, a brake pedal 144 (or “pedal” 144). The brake system 142 is a brake-by-wire system that uses pedal sensors and actuators to engage the brakes rather than a direct mechanical connection between the brake pedal and the master cylinder. The pedal sensors are configured to sense movement of the brake pedal 144 and output a signal indicative of this movement. The signals include data indicative of a position of the brake pedal 144, which may be expressed as a percentage of depression. The pedal sensors may be redundant sensors designed to output the same value i.e., within a threshold, during proper operation of the system. The pedal sensors output this data to a braking control module of the controller(s) 138.

The vehicle 112 is configured to brake using powertrain braking (e.g., regenerative braking), friction braking, or a combination thereof. The brake system 142 may include one or more brake control modules including programming for aggregating a demanded braking torque between the electric machine 114 and the friction brakes 140. The demanded braking torque may be based on driver input, e.g., a position of the brake pedal 144, or by the controller 138 in a two-pedal driving mode. The aggregator may be programmed to slow the vehicle 112 using regenerative braking whenever possible and apply the friction brakes 140 when necessary.

The controller 138 may be programmed to receive the pedal-position signal (e.g., control signal) having a parameter indicative of travel of the pedal 144 and determine the driver-demanded torque based on pedal position and other factors such as vehicle speed. The controller 138 may include multiple lookup tables or maps for determining the driver-demanded torque. These maps indicate the driver-demanded torque based on inputs such as brake pedal position, vehicle speed, and other factors.

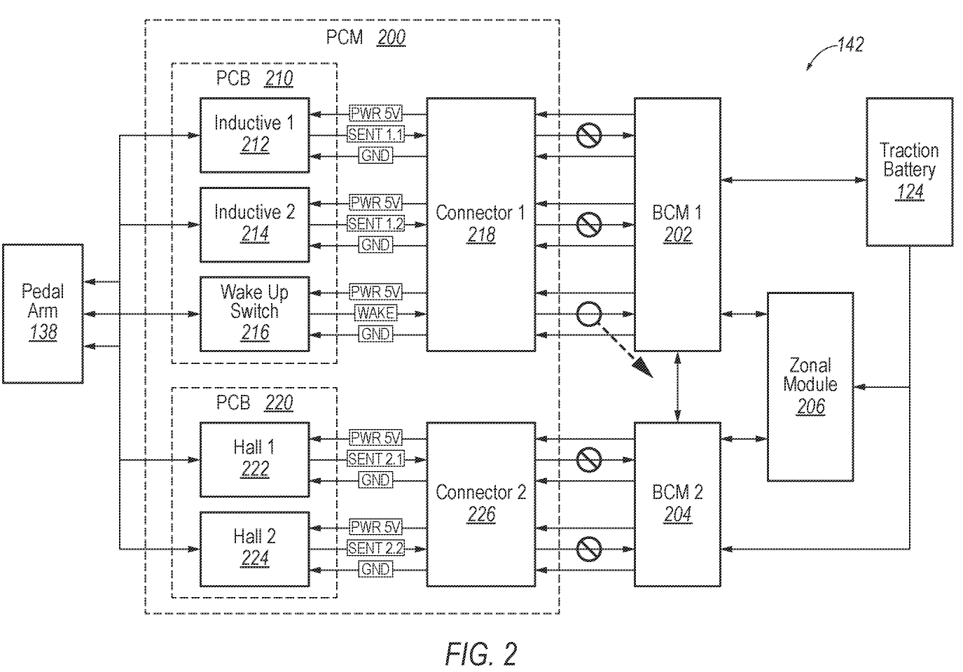

FIG. 2 shows a circuit diagram depicting a configuration of the brake system 142 within the vehicle 112. As described above, the controller 138 may communicate with the brakes 140 via the brake system 142 (e.g., via braking modules) in order to actuate the brakes 140 according to the control signal. For example, the controller 138 may receive control signals from the pedal 144 via the brake system 142. The brake system 142 may include a pedal control module (PCM) 200 having a first printed circuit board (PCB) 210 and a second PCB 220. Each component within the PCM 200 may have a plurality of connections between various other components. For example, each component receives 5V of power from the traction battery 124 and is provided a ground connection. The components are configured to transmit signals indicative of components status (e.g., SENT 1.1, SENT 1.2, SENT 2.1, SENT 2.2, WAKE). Further, the brake system 142 may further include a first brake control module (BCM) 202, a second BCM 204, and a zonal module (e.g., a third BCM) 206. Each component of the brake system may be electrically connected with, and receive power from, the traction battery 124 and the auxiliary battery 130. The brake system 142 includes multiple PCBs 210, 220 and multiple BCMs 202, 204, 206 for the purposes of redundancy such that, in a hypothetical scenario where one component is not functioning as designed, the vehicle 112 is still able to have braking force applied due to the operation of the redundant components.

The PCM 200 includes the first PCB 210 including a first inductive component 212 and a second inductive component 214. An inductive component, or “inductive,” is an electronic component of the PCB which stores electrical energy in a magnetic field that is measurable by a sensor to indicate pedal travel. The pedal 144 may support a magnetic component. As the pedal 144 is depressed and/or released (e.g., as the pedal 144 travels) the travel of the pedal 144 correlates to travel of the magnetic component relative to the inductive component of the inductive sensors 212, 214. This movement induces the magnetic field at the inductive sensors 212, 214. The change in the magnetic field is converted into an electrical signal (e.g., the control signal) SENT 1.1 and SENT 1.2 which is provided to the first BCM 202 via a first electrical connector 218. In this way, the brake system 142 may utilize a plurality of inductive sensors 212, 214 to generate a control signal which the controller 138 may use to actuate the brakes 140 based on the parameter values of the signals which are indicative of pedal travel.

The PCM 200 includes the second PCB 220 having a first hall sensor 222 and a second hall sensor 224. A Hall effect sensor, or “Hall” is an electrical component which detects rotational spread of the wheels 122 via the Hall effect whereby a magnetic field perpendicular to an electrical current flow induces a voltage across a sensor. Therefore, the first Hall 222 and the second Hall 224 provide further control signals, SENT 2.1 and SENT 2.2, to the controller 138 such that the controller may actuate the brakes 140 based on the parameter values indicative of pedal travel included in such signals. The signals from the Halls 222, 224 may be sent to the controller 138 via a second connector 226 and the second BCM 204. Each of the signals received by the first BCM 202 and the second BCM 204 may be transmitted to the third BCM 206. The third BCM 206 may, similar to the first and second BCMs 202, 204, communicate with the controller 138 to transmit the control and wake signals.

The first PCB 210 of the PCM 200 may include a wakeup switch 216 configured to send a wakeup signal. The wakeup switch 216 is an electrical component that is configured to transmit a signal throughout the brake system 142 responsive to specified events. The wakeup switch 216 may include a plurality of wake pins. In this example, the wakeup switch 216 may be configured to transmit a wakeup signal based on a specified travel of the pedal 144. That is, when the pedal 144 is depressed by a specified travel amount (e.g., 5%, 20%, etc.) the wake pins of the wakeup switch 216 may become active and transmit the wakeup signal. The wakeup signal prompts the components of the brake system 142 (e.g., inductive 212, 214, hall 222, 224, BCMs 202, 204, 206, etc.) to transition from a first power mode (e.g., a low power mode) to a second higher power mode (e.g., an active state). The second higher power mode may be a wake mode. The wake mode is a power state in which the components of the brake system 142 are receiving full power and prepared to be actuated at a normal operating mode.

Generally, the controller 138 and the brake system 142 use the wakeup signal to transition components to an active state in preparation for braking operations. FIG. 2 illustrates BCMs 202, 204 either not receiving the control signals SENT 1.1, SENT 1.2, SENT 2.1, SENT 2.2 from the inductive sensors 212, 214 and Halls 222, 224 or determining that the control signals are faulty as indicated by the cancellation symbol between the first connector 218 and first BCM 202 as well as between the second connector 226 and second BCM 204. In a scenario where the control signals (e.g., SENT 1.1, SENT 1.2, SENT 2.1, SENT 2.2) are either not transmitted or are determined to be faulty by the controller 138, the controller 138 may treat the wakeup signal as the control signal and/or actuate the brakes 140 based on the wakeup signal as described below.

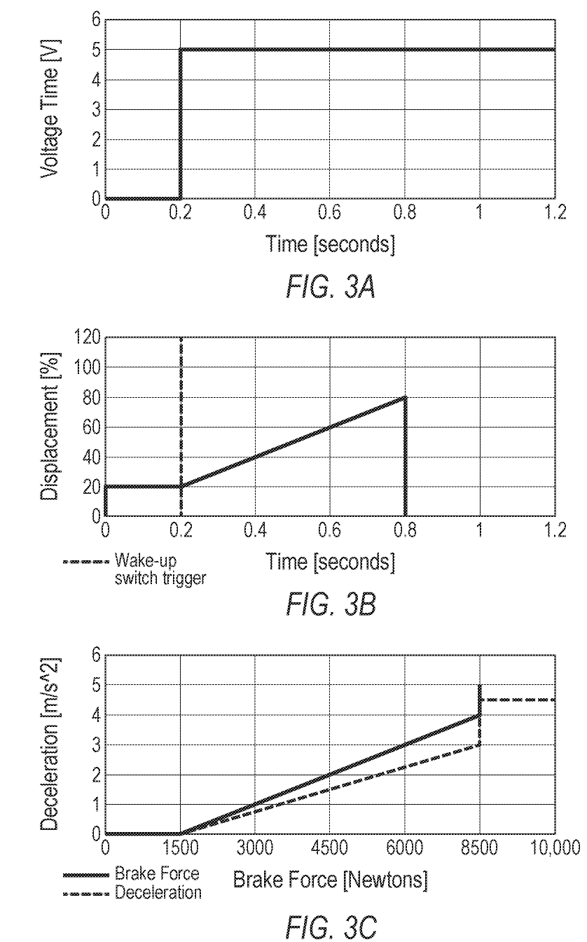

FIG. 3A shows a plot illustrating the wakeup signal over time. At T0, a transitioning event has not yet occurred and the components of the brake system 142 remain at a reduced power mode. At 0.2 seconds, the transition event occurs. As mentioned above, the transition event may be any specified event configured to cause the wakeup pins to transmit the wakeup signal. In this example, the transition event may be a sufficient depression of the pedal 144 (e.g., 20% travel). Responsive to the specified wakeup travel of the pedal 144, the wake pins activate and send the wakeup signal. In this specific example, the wake pins being actuated causes a 5V wakeup signal to be sent. As shown, the wakeup signal is binary and remains active at 5V while the pedal 144 is depressed at or beyond the specified wakeup pedal travel.

FIG. 3B shows a plot illustrating operation of the control signals SENT 1.1, SENT 1.2, SENT 2.1, SENT 2.2 over time. In this scenario, the specified wakeup pedal travel amount may be 5%, 10%, or any travel percentage up to and including 20%. As shown, the pedal 144 is depressed to 20% of its overall travel distance at 0.2 seconds. As 20% exceeds or meets the wakeup threshold, the wakeup switch 216 generates the wakeup signal and transmits the signal throughout the brake system 142, thereby transitioning the brake system 142 into the wake mode. From 0.2 seconds to 0.8 seconds the four control signals indicate that the pedal travel increases linearly from 20% to 80%. At 0.8 seconds an event occurs which either renders the control signals faulty or interrupts the transmission of the control signals. Therefore, the controller 138 determines that the control signals are faulty or determines that the control signals are absent and flags the wakeup signal as the new control signal. The controller 138 may, upon determining that the control signals are faulty and/or that the control signals are absent, transition the vehicle to a limp mode. The vehicle 112 may be in limp mode while the brake system 142 is in the wake mode. As generally understood, the limp mode is a vehicle state in which the controller 138 actuates vehicle components and subsystems to minimize potential wear to the vehicle 112. For example, in limp mode the controller 138 may limit an output of the engine 118 or electric machines 114 or, as described herein, treat the wakeup signal as the control signal within the brake system 142.

In a scenario where the controller 138 treats the wakeup signal as the control signal, the controller 138 may actuate the brake system 142 to apply a specified brake force to the brakes 140. Additionally, or alternatively, the controller 138 may actuate the brake system 142 to apply varying brake forces to each individual brake 140A, 140B, 140C, 140D. For example, the controller 138 may store a lookup table specifying a brake force to apply in order to achieve a specified slowing based on detecting the wakeup signal when each of the control signals are either faulty or absent. The lookup table may specify varying braking forces to apply to achieve specified vehicular speed decreases based on weather, vehicle speed, road conditions, etc. The lookup table may, in a scenario where the controller 138 is configured to apply varying brake forces to the brakes 140A, 140B, 140C, 140D, further specify the specific brake forces for each for each of the respective brakes 140A, 140B, 140C, 140D.

FIG. 3C shows a plot illustrating brake force (N) and vehicle rate of speed decrease (m/s^2) over time in a scenario where the brake is depressed and the control signals are either faulty or absent. At 0.2 seconds, the wakeup signal is transmitted and the brake system 142 is transitioned to the wake mode. As the travel of the pedal 144 increases, the force applied by brakes 140 increases and the vehicle rate of speed decreases. At 0.8 seconds the control signals either become faulty or are prevented from transmitting. The controller 138 then determines that the control signals are faulty or determines that the control signals are absent and flags the wakeup signal as the new control signal. The controller 138 then actuates the brakes 140 to apply a specified braking force to achieve a specified vehicle rate of speed decrease. The controller 138 may consult the stored lookup tables and, as illustrated here, determine that in order to achieve the specified rate of 4.5m/s^2, the brakes must apply a force of 8500N. Additionally, while in limp mode, when the controller 138 determines that the vehicle 112 has come to a full stop the controller 138 may actuate a parking brake 146 of the brake system 142 to prevent any additional movement of the vehicle 112. The parking brake 146 may be a subsystem or module of the brake system 142 which is actuatable by the controller 138 to keep the vehicle 112 stationary after movement has ceased. The parking brake 146 may operate via a direct cable connection to the rear brakes 140C, 140D of the vehicle 112. As another example, the parking brake 146 may actuate each of the brakes 140A, 140B, 140C, 140D to apply brake force. Additionally, the vehicle 112 may utilize parking pawls (not numbered) supported by the transmission 116 in order to prevent movement of the vehicle 112 after movement has ceased. The vehicle 112 may include parking pawls, for example, when the vehicle 112 is an electric-hybrid vehicle.

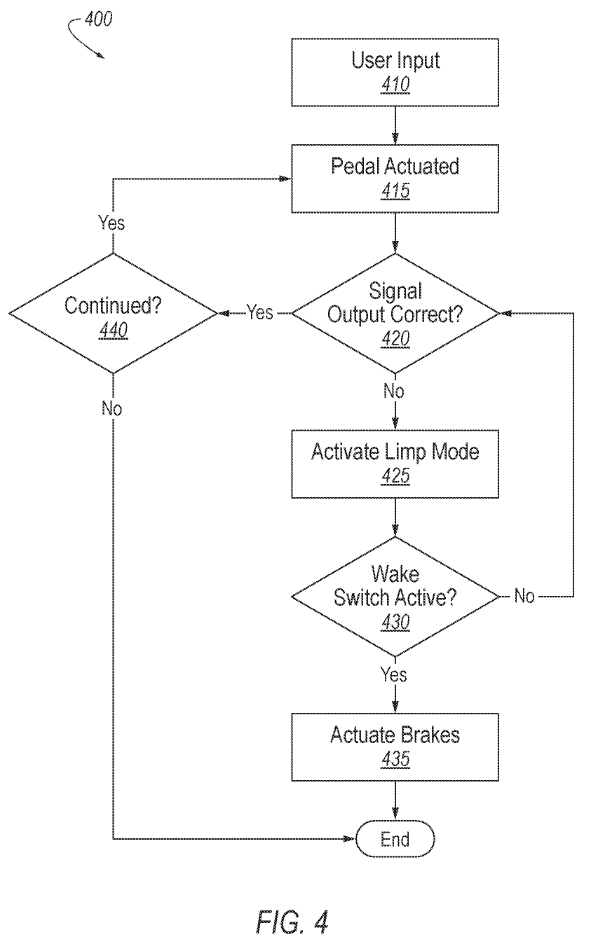

FIG. 4 is a flowchart illustrating an example process 400 for actuating a vehicle brake system 142 based on the wakeup signal. A computer such as the controller 138 may store executable instructions for performing the steps of the process 400 and/or programming can be implemented in structures such as those mentioned above. The process 400 may continue for as long as the vehicle 112 is in the limp mode (e.g., as long as the control signals are faulty and/or absent).

The process begins in block 410 in which the controller 138 receives user input (e.g., via depression of the pedal 144) which actuates the wake pins and thereby causes the wakeup switch 216 to transmit the wakeup signal to the brake system 142. As discussed above, the user input may be a specified travel of the pedal 144 up to a specified wake threshold. The wakeup switch 216 transmits the wakeup signal which transitions the brake system 142 to the wake mode.

In block 415, the controller 138 receives sensor data indicative of travel of the pedal 144 beyond the wake threshold. That is, the pedal 144 has been depressed to the point (e.g., 20% of travel) of causing the wakeup switch 216 to send the wakeup signal and for the controller 138 to transition the brake system 142 to the wake mode. Subsequently, the pedal 144 continues to travel past the wake threshold (e.g., past 20%).

In block 420, the controller 138 determines whether the control signals have been received and are correct. If the control signals are correct and have been received by the controller 138, then the process 400 continues to block 440. Otherwise, if the control signals are absent from the controller 138 and/or the controller 138 determines them to be faulty, the process 400 continues to block 425.

In block 425, the controller 138 transitions the vehicle 112 to the limp mode in response to determining that the control signals are faulty and/or absent from the controller 138.

In block 430, the controller 138 determines whether the wakeup switch 216 is active. That is, generally, once the brake system 142 is transitioned to the wake mode initially the wake pins are themselves transitioned to a reduced power mode. However, in a limp mode scenario as described herein, the controller 138 may keep the wake pins actuated in order to detect travel of the pedal 144 which meets or exceeds the wake threshold travel. In this way the controller 138 may continue to receive the wake signal when the pedal 144 is depressed despite the control signals being faulty and/or absent. If the wakeup switch 216 is active (e.g., if the controller 138 has actuated the wakeup switch 216 in response to entering the limp mode) the process 400 continues to block 435. Otherwise, the process returns to block 420.

In block 435, the controller 138 actuates the brake system 142 and brakes 140 to apply brake force in response to the wakeup signal in the limp mode. As described above the controller 138 may store a plurality of lookup tables specifying both the specified rate of speed decrease and the brake force required to achieve the specified rate of speed decrease based on any plurality of environmental factors (e.g., road conditions, weather conditions, vehicle conditions, etc.). After consulting the lookup tables and determining the required brake force, the controller 138 actuates the brakes 140 to apply the specified force in order to achieve the specified vehicular rate of speed decrease. The process then ends.

In block 440, the controller 138 has previously determined that the control signals have been received and are correct. The controller 138 then determines whether to continue the process 400. The controller 138 may continue the process 400 as long as the vehicle 112 remains in an on state and may terminate the process 400 in response to deactivation of the vehicle 112, interference of an overriding process, etc. If the controller 138 determines to continue the process 400, it returns to block 415 where the controller 138 receives data indicative of pedal travel from the brake system 142. Otherwise, the process 400 ends.

Computing devices, like the controllers suggested above, generate commands that can be executed to carry out the processes outlined. These computer-executable commands may be compiled or interpreted from programs created using various programming languages and technologies, including, but not limited to, Java™, C, C++, Python, Julia, SCALA, Visual Basic, JavaScript, Perl, and HTML. Typically, a processor (e.g., a microprocessor) receives these commands from a memory or another computer-readable medium and executes them, thereby performing one or more processes, including those described herein. Such commands, along with other data, may be stored in files and transmitted through various computer-readable media. In computing, a file is generally a collection of data stored on a computer-readable medium, such as a storage drive or random-access memory.

A computer-readable medium (also referred to as a processor-readable medium) is any non-transitory (i.e., tangible) medium that provides data, including instructions, which can be read by a processor of a computing device. This medium can take many forms, including non-volatile media (e.g., storage drives) and volatile media (e.g., RAM). Instructions may also be transmitted through transmission media such as fiber optics, wired connections, or wireless communication systems, including internal system buses connected to the processor of a computing device. Common examples of computer-readable media include RAM, PROM, EPROM, FLASH-EEPROM, memory chips or cartridges, or any other medium that a computing device can read.

While exemplary embodiments have been described above, these embodiments are not intended to encompass all possible implementations. The language used in the specification serves as a description rather than a limitation, and various modifications may be made without departing from the spirit and scope of the subject matter described. Additionally, features from different embodiments may be combined to create further implementations within the scope of the claims.

What is claimed is:

1. A vehicle brake system comprising:
a brake;
an electronic pedal system including a pedal arm and circuitry configured to, responsive to engagement of the pedal arm, generate a wakeup signal and, responsive to subsequent travel of the pedal arm, generate a control signal having a parameter value defined by the travel; and
one or more controllers programmed to, responsive to the wakeup signal, enter a wake mode, responsive to the control signal being present and not faulty while in the wake mode, actuate the brake according to the parameter value, and responsive to the control signal being absent while in the wake mode, actuate the brake to achieve a target vehicle rate of speed decrease regardless of the travel.

2. The system of claim 1, wherein the one or more controllers are further programmed to, responsive to the control signal being faulty, actuate the brake to achieve the target vehicle rate of speed decrease regardless of the travel.

3. The system of claim 2, wherein the electronic pedal system further includes a plurality of wake pins configured to be inactivate during the wake mode while the control signal is present and not faulty and to be active during the wake mode while the control signal is faulty.

4. The system of claim 1, wherein the electronic pedal system further includes a plurality of wake pins configured to be inactivate during the wake mode while the control signal is present and not faulty and to be active during the wake mode while the control signal is absent.

5. The system of claim 1, wherein the one or more controllers are redundant brake modules.

6. The system of claim 1 further comprising a parking brake, wherein the one or more controllers are further programmed to, after stopping due to actuation of the brake to achieve the target vehicle rate of speed decrease, actuate the parking brake.

7. A method comprising:
actuating a brake according to a parameter value indicative of travel of a brake pedal arm in response to a control signal that defines the parameter value; and
actuating the brake to achieve a target vehicle rate of speed decrease regardless of the travel in response to the control signal being faulty.

8. The method of claim 7, further comprising actuating the brake to achieve the target vehicle rate of speed decrease regardless of the travel in response to the control signal being absent.

9. The method of claim 8, while the control signal is absent, activating a plurality of wake pins configured to receive a wakeup signal.

10. The method of claim 9 further comprising generating the wakeup signal after engagement of the brake pedal arm.

11. The method of claim 7, while the control signal is faulty, activating a plurality of wake pins configured to receive a wakeup signal.

12. The method of claim 11 further comprising generating the wakeup signal after engagement of the brake pedal arm.

13. The method of claim 7 further comprising, after stopping due to the actuating the brake to achieve the target vehicle rate of speed decrease, actuating a parking brake.

14. A vehicle brake control system comprising:
one or more brake controllers configured to actuate a brake according to a parameter value that is defined by a control signal and is indicative of travel of a brake pedal arm, and to actuate the brake to achieve a target vehicle rate of speed decrease regardless of the travel while the control signal is absent.

15. The system of claim 14, wherein the one or more brake controllers are further configured to, while the control signal is faulty, actuate the brake to achieve the target vehicle rate of speed decrease regardless of the travel.

16. The system of claim 14, wherein the one or more brake controllers include a first brake module, a second brake module, and a third brake module.

17. The system of claim 16, wherein the first brake module, second brake module, and third brake module are redundant brake modules.

18. The system of claim 14, wherein the one or more brake controllers are further configured to keep wake pins, configured a receive a wakeup signal, active while the brake is being actuated to achieve the target vehicle rate of speed decrease.

19. The system of claim 14, wherein the one or more brake controllers are further configured to, after stopping due to the brake being actuated to achieve the target vehicle rate of speed decrease, actuate a parking brake.

20. The system of claim 14, wherein the one or more brake controllers are further configured to generate the control signal after engagement of the brake pedal arm.
